(19) United States
(12) Patent Application Publication
(10) Pub. No.: US 2013/0051182 A1
(43) Pub. Date: Feb. 28, 2013

(54) ELECTRONIC DEVICE, STORAGE MEDIUM AND METHOD FOR SETTING AN ALARM FUNCTION OF THE ELECTRONIC DEVICE

(71) Applicant: Kai-Bo QU, Shenzhen City (CN)

(72) Inventor: Kai-Bo QU, Shenzhen City (CN)

(73) Assignees: Chi Mei Communication Systems, Inc., Tu-Cheng (TW); SHENZHEN FUTAIHONG PRECISION INDUSTRY CO., LTD., ShenZhen City (CN)

(21) Appl. No.: 13/561,061

(22) Filed: Jul. 29, 2012

(30) Foreign Application Priority Data
Aug. 31, 2011 (CN) 201110254647.3

(51) Int. Cl. G04B 19/24

(52) U.S. Cl. 368/29

(57) ABSTRACT

A method sets an alarm function of an electronic device. The method obtains dates and indicators corresponding to the dates from a database after the electronic device logs into the database of a server, and determines whether the alarm function needs to be set according to the indicators corresponding to the dates. If the set alarm function of the date is in accordance with a default rule, a date of the electronic device does not need to update the alarm function. If the set alarm function of the date is not in accordance with the default rule, a date of the electronic device needs to update the alarm function.

### BACKGROUND

1. Technical Field

Embodiments of the present disclosure relate to alarm systems and methods, and more particularly to an electronic device, a storage medium and a method for setting an alarm function of the electronic device.

2. Description of Related Art

Electronic devices often provide an alarm function that can be set to output voice alarms at a specific time. A user usually sets an alarm clock to sound an alarm during weekdays. Sometimes, the user may be late for forgetting setting the alarm clock when the user needs to work on weekend, and the user may be awakened by the alarm clock when the user does not need to work on a weekday. That is, it is not convenient for the user as the alarm function must be set manually.

### BRIEF DESCRIPTION OF THE DRAWINGS

FIG. 1 is a block diagram of one embodiment of an electronic device including an alarm function setting system and a display screen.

FIG. 2 is a block diagram of function modules of an alarm function setting system in the electronic device of FIG. 1.

FIG. 3 is a flowchart of one embodiment of a method for setting an alarm function of the electronic device of FIG. 1.

FIG. 4 illustrates a storage form of data in a database.

FIG. 5 illustrates a calendar after setting the alarm function according to the database in FIG. 4.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

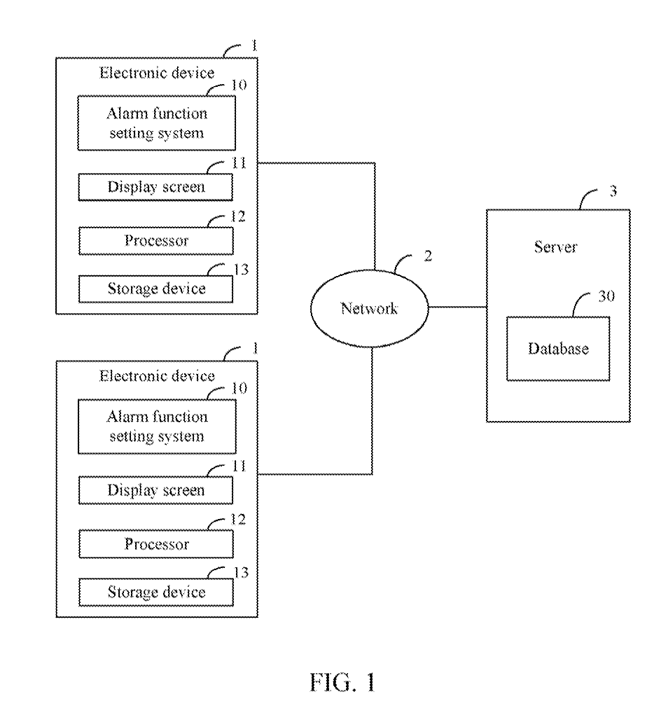

FIG. 1 is a block diagram of one embodiment of an electronic device 1 including an alarm function setting system 10 and a display screen 11. The alarm function setting system 10 may set an alarm function of the electronic device 1 according to work situations of a user. The work situations of the user are situations where the user goes to work or has a rest in a day, for example, the user goes to work from Monday to Saturday and has a rest on Sunday. The display screen 11 displays a calendar corresponding to the alarm function.

The electronic device 1 further includes a processor 12 and a storage device 13. The processor 12 executes one or more computerized codes and other applications for the electronic device 1, to provide functions of the alarm function setting system 10. The storage device 13 stores the calendar. The storage device 13 may be a memory, an external storage card, such as a smart media card, or a secure digital card.

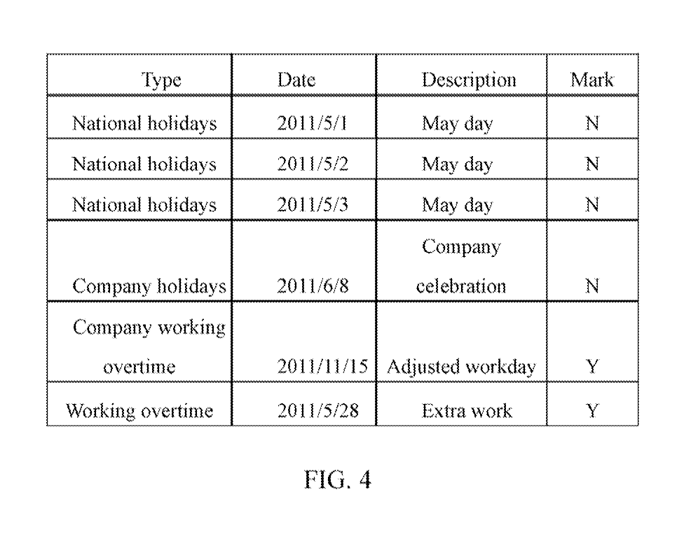

In one embodiment, one or more electronic devices 1 may connect to a server 3 through a network 2. As shown in FIG. 1, only two electronic devices 1 connect to the server 3. The network 2 may be a mobile communication network with a General Packet Radio Service (GPRS) technology, or a mobile communication network with a High Speed Circuit Switched Data (HSCSD) technology, or a mobile communication network with an Enhanced Data Rate for GSM Evolution (EDGE) technology. The server 3 may be a computing device including a database 30 that stores data in relation to the work situations of the user. In one embodiment, the database 30 has two kinds of data. A first kind data is work information and holiday information that a company of the user publishes, and a second kind data is work information and leave information that the user submits to the company. As shown in FIG. 4, the data from the second row to the sixth row belong to the first kind of data, and the data of the seventh row belongs to the second kind of data.

In one embodiment, the database 30 in FIG. 4 includes a type field, a date field, a description field, and a mark field. The database 30 may increase or decrease the number of fields according to requirements of the user. The type field is used to introduce the type of the data, for example, national holidays, company holidays, company working overtime, working overtime, etc. The date field is used to label a specified date. The description field is used to describe the date corresponding to the date field. The mark field includes an indicator to distinguish whether the user goes to work or has a rest corresponding to the date of the date field. For example, indicator “Y” corresponds to when the user has a rest corresponding to the date of the date field, indicator “N” corresponds to when the user goes to work corresponding to the date of the date field.

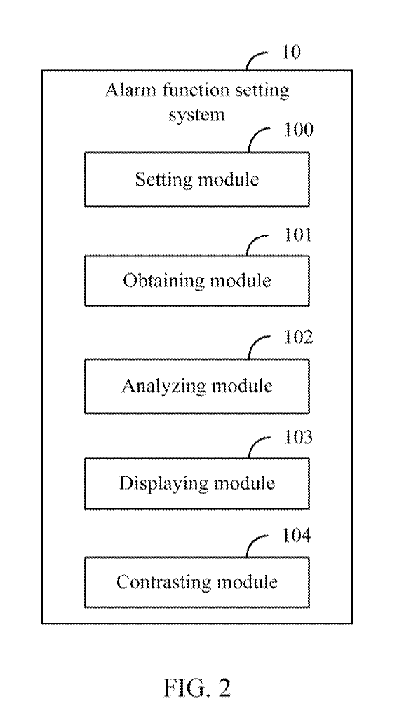

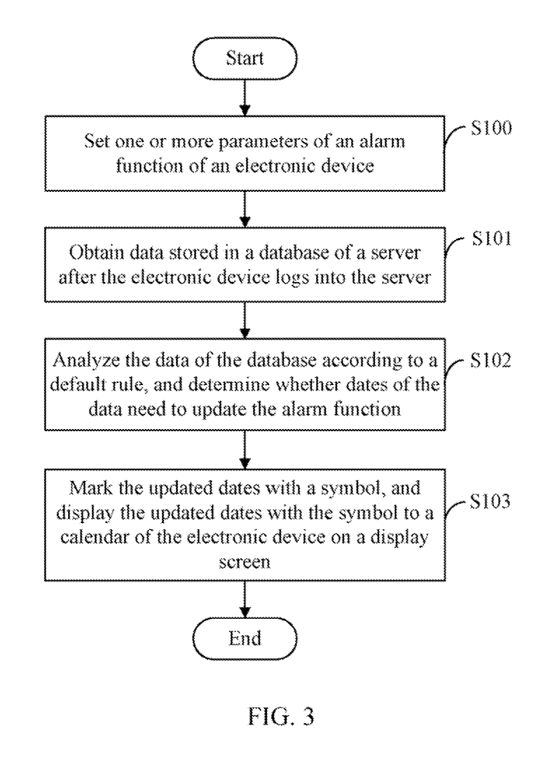

FIG. 2 is a block diagram of function modules of the alarm function setting system 10 in the electronic device 1 of FIG. 1. In one embodiment, the alarm function setting system 10 may include a setting module 100, an obtaining module 101, an analyzing module 102, a displaying module 103, and a contrasting module 104. The modules 100-104 comprise computerized codes in the form of one or more programs that are stored in the storage device 13. The computerized code includes instructions that are executed by the processor 12 to provide functions for the modules. Details of each of the modules are given in FIG. 3.

FIG. 3 is a flowchart of one embodiment of a method for setting an alarm function of the electronic device 1 of FIG. 1. Depending on the embodiment, additional steps may be added, others removed, and the ordering of the steps may be changed.

It should be understood that the alarm function of the electronic device 1 is set by the user according to a default rule (e.g., a predetermined rule or a user-determined rule). The default rule is a rule that defines some days set the alarm function, and some days do not set the alarm function. For example, the default rule may be setting the alarm function on weekdays (from Monday to Friday), and not setting the alarm function on weekends (Saturday and Sunday). When the user needs to work in the days that do not include a set alarm function, the user may add the alarm function to those days. When the user does not need to work in the days that include a set alarm function, the user may delete the alarm function of those days. It is not convenient for the user to adjust the alarm function. However, with the present alarm function setting system 10, the electronic device 1 can update the alarm function according to the work situations of the user. The user does not need to adjust the alarm function manually.

In step S100, the setting module 100 sets one or more parameters of the alarm function of the electronic device 1. In one embodiment, the parameters of the alarm function includes an alarm mode (e.g., a ring mode or a vibration mode), an alarm time (e.g., seven o'clock), a time duration ring again (e.g., 5 minutes), etc.

In step S101, the obtaining module 101 obtains the data stored in the database 30 of the server 3 after the electronic device 1 logs into the server 3. In one embodiment, the electronic device 1 may log into the server 3 in an anonymous login method or in a user name and password method. In the anonymous login method, the electronic device 1 only obtains the first kind data that the company of the user publishes in the database 30. In the user name and password method, the electronic device 1 obtains all data of the database 30.

In the user name and password method, the obtaining module 101 saves the set parameters of the alarm function to the sever 3. When the electronic device 1 loses the set parameters of the alarm function, the electronic device 1 can directly obtain the set parameters from the server 3.

In one embodiment, the server 3 records a time of when the data of the database 30 changes (“the database update time”). When the electronic device 1 obtains the data of the database 30 from the server 3, the server 3 also records the obtained time as a clock data update time of the electronic device 1. The clock data update time is the time that the dates (e.g. 2011-5-28) of the electronic device 1 including the alarm function change according to the changed data of the database 30.

In one embodiment, when the electronic device 1 logs in the server 3 in the user name and password method, the contrasting module 104 obtains the database update time and the clock data update time from the server 3. The contrasting module 104 also determines whether the database update time is before the clock data update time. If the database update time is before the clock data update time, the contrasting module 104 determines that the data of the database 30 needs to be analyzed. If the database update time is not before the clock data update time, the contrasting module 104 determines that the data of the database 30 does not need to be analyzed.

In step S102, the analyzing module 102 analyzes the data of the database 30 according to the default rule, and determines whether the dates of the data need to update the alarm function. In one embodiment, the analyzing module 102 obeys the default rule that the electronic device 1 sets the alarm function on weekdays, and the electronic device 1 does not set the alarm function on weekends. To update the alarm function is to cancel the alarm function when the date has been set alarm function according to the default rule, or to set the alarm function to the date when the date has not been set alarm function according to the default rule.

In detail, the analyzing module 102 obtains the dates of the date field and the indicators of the mark field from the data of the database 30, and compares the dates with the calendar of the electronic device 1 to determine whether each of the dates of the date field is a weekday. The analyzing module 102 further determines whether the alarm function needs to be set according to the indicators corresponding to the dates. If the set alarm function of the date is in accordance with the default rule, a date of the electronic device 1 does not need to update the alarm function. If the set alarm function of the date is not in accordance with the default rule, a date of the electronic device 1 needs to update the alarm function.

In one embodiment, when the date of the electronic device 1 is a weekend, and the indicator corresponding to the date corresponds to when the user has a rest in the date, the analyzing module 102 determines that the date of the electronic device 1 does not need to set the alarm function. It is known that the set alarm function of the date is in accordance with the default rule, and the analyzing module 102 determines that the alarm function of the date does not need to be updated. When the date of the electronic device 1 is a weekday, and the indicator corresponding to the date corresponds to when the user has a rest in the date, the analyzing module 102 determines that the date of the electronic device 1 does not need to set the alarm function. It is known that the set alarm function of the date is not in accordance with the default rule, and the analyzing module 102 determines that the alarm function of the date needs to be updated (that is, cancel the alarm function of the date).

In one embodiment, when the date of the electronic device 1 is a weekend, and the indicator corresponding to the date corresponds to when the user goes to work in the date, the analyzing module 102 determines that the date of the electronic device 1 needs to set the alarm function. It is known that the set alarm function of the date is not in accordance with the default rule, and the analyzing module 102 determines that the alarm function of the date needs to be updated (that is, set alarm function for the date). When the date of the electronic device 1 is a weekday, and the indicator corresponding to the date corresponds to when the user goes to work in the date, the analyzing module 102 determines that the date of the electronic device 1 needs to set the alarm function. It is known that the set alarm function of the date is in accordance with the default rule, and the analyzing module 102 determines that the alarm function of the date does not need to be updated.

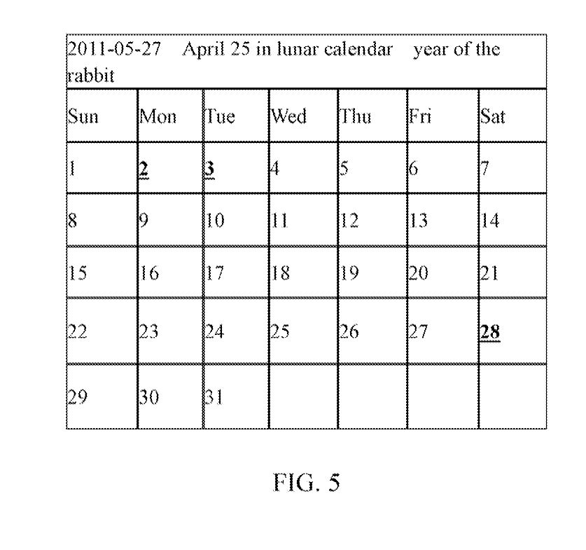

In step S103, the displaying module 103 marks the updated dates with a symbol, and displays the updated dates with the symbol to the calendar of the storage device 13 on the display screen 11. In one embodiment, the symbol may underscore the font of the updated date; or may show the updated date in bold font; or may mark the font of the updated date with color; or may suspend the font of the updated date. As shown in FIG. 5, the font of the updated date is underscored in bold in the calendar.

All of the processes described above may be embodied in, and be fully automated via, functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for setting an alarm function of an electronic device, the method comprising:
logging into a database of a server;
obtaining dates and indicators corresponding to the dates from the database;
comparing the dates with a calendar of the electronic device to determine whether each of the dates is a weekday;
determining whether the alarm function needs to be set according to the indicators corresponding to the dates;
determining a date of the electronic device that does not update the alarm function when the set alarm function of the date is in accordance with a default rule, wherein the default rule is a rule that defines one or more dates that set the alarm function, and one or more dates that do not set the alarm function; and
determining a date of the electronic device that updates the alarm function when the set alarm function of the date is not in accordance with the default rule.

2. The method as claimed in claim 1, further comprising:
marking the dates that update the alarm function with a symbol, and displaying the dates that update the alarm function with the symbol on the calendar of the electronic device on a display screen.

3. The method as claimed in claim 1, further comprising:
obtaining a database update time and a clock data update time from the server, wherein the database update time is a time that data of the database changes, and the clock data update time is a time that the dates including the alarm function change according to the change data of the database;
determining whether the database update time is before the clock data update time;
determining that the data of the database needs to be analyzed if the database update time is before the clock data update time; and
determining that the data of the database does not need to be analyzed if the database update time is not before the clock data update time.

4. The method as claimed in claim 1, wherein the indicator of the database distinguishes whether a user goes to work or has a rest corresponding to the date.

5. The method as claimed in claim 1, wherein the default rule is used to set the alarm function of the electronic device on weekdays, and is not used to set the alarm function of the electronic device on weekends.

6. The method as claimed in claim 5, further comprising:
determining that the date of the electronic device does not need to set the alarm function and determining that the alarm function of the date does not need to be updated when the date of the electronic device is a weekend and the indicator corresponding to the date corresponds to when the user has a rest in the date;
determining that the date of the electronic device does not need to set the alarm function and determining that the alarm function of the date needs to be updated when the date of the electronic device is a weekday and the indicator corresponding to the date corresponds to when the user has a rest in the date;
determining that the date of the electronic device needs to set the alarm function and determining that the alarm function of the date needs to be updated when the date of the electronic device is a weekend and the indicator corresponding to the date corresponds to when the user goes to work in the date; and
determining the date of the electronic device needs to set the alarm function and determining that the alarm function of the date does not need to be updated when the date of the electronic device is a weekday and the indicator corresponding to the date corresponds to when the user goes to work in the date.

7. A non-transitory computer readable storage medium storing a set of instructions, when executed by at least one processor of an electronic device, cause the at least one processor to perform a method for setting an alarm function of the electronic device, the method comprising:
logging into a database of a server;
obtaining dates and indicators corresponding to the dates from the database;
comparing the dates with a calendar of the electronic device to determine whether each of the dates is a weekday;
determining whether the alarm function needs to be set according to the indicators corresponding to the dates;
determining a date of the electronic device that does not update the alarm function when the set alarm function of the date is in accordance with a default rule, wherein the default rule is a rule that defines one or more dates that set the alarm function, and one or more dates that do not set the alarm function; and
determining a date of the electronic device that updates the alarm function when the set alarm function of the date is not in accordance with the default rule.

8. The non-transitory computer readable storage medium as claimed in claim 7, wherein the method further comprises:
marking the dates that update the alarm function with a symbol, and displaying the dates that update the alarm function with the symbol on the calendar of the electronic device on a display screen.

9. The non-transitory computer readable storage medium as claimed in claim 7, wherein the method further comprises:
obtaining a database update time and a clock data update time from the server, wherein the database update time is a time that data of the database changes, and the clock data update time is a time that the dates including the alarm function change according to the change data of the database;
determining whether the database update time is before the clock data update time;
determining that the data of the database needs to be analyzed if the database update time is before the clock data update time; and
determining that the data of the database does not need to be analyzed if the database update time is not before the clock data update time.

10. The non-transitory computer readable storage medium as claimed in claim 7, wherein the indicator of the database distinguishes whether a user goes to work or has a rest corresponding to the date.

11. The non-transitory computer readable storage medium as claimed in claim 7, wherein the default rule is used to set the alarm function of the electronic device on weekdays, and is not used to set the alarm function of the electronic device on weekends.

12. The non-transitory computer readable storage medium as claimed in claim 11, wherein the method further comprises:
determining that the date of the electronic device does not need to set the alarm function and determining that the alarm function of the date does not need to be updated when the date of the electronic device is a weekend and the indicator corresponding to the date corresponds to when the user has a rest in the date;
determining that the date of the electronic device does not need to set the alarm function and determining that the alarm function of the date needs to be updated when the date of the electronic device is a weekday and the indicator corresponding to the date corresponds to when the user has a rest in the date;
determining that the date of the electronic device needs to set the alarm function and determining that the alarm function of the date needs to be updated when the date of the electronic device is a weekend and the indicator corresponding to the date corresponds to when the user goes to work in the date; and
determining the date of the electronic device needs to set the alarm function and determining that the alarm function of the date does not need to be updated when the date of the electronic device is a weekday and the indicator corresponding to the date corresponds to when the user goes to work in the date.

13. An electronic device, comprising:
a storage device;
at least one processor; and
one or more programs that are stored in the storage device and executed by the at least one processor, the one or more programs comprising:
an obtaining module that logs into a database of a server and obtains dates and indicators corresponding to the dates from the database; and
an analyzing module that compares the dates with a calendar of the electronic device to determine whether each of the dates is a weekday, determines whether the alarm function needs to be set according to the indicators corresponding to the dates, determines a date of the electronic device that does not update the alarm function when the set alarm function of the date is in accordance with a default rule, and determines a date of the electronic device that updates the alarm function when the set alarm function of the date is not in accordance with the default rule, wherein the default rule is a rule that defines one or more dates that set the alarm function, and one or more dates that do not set the alarm function.

14. The electronic device as claimed in claim 13, wherein the one or more programs further comprise a displaying module that marks the dates that update the alarm function with a symbol, and displays the dates that update the alarm function with the symbol on the calendar of the electronic device on a display screen.

15. The electronic device as claimed in claim 13, wherein the one or more programs further comprises a contrasting module that obtains a database update time and a clock data update time from the server, determines whether the database update time is before the clock data update time; determines that data of the database needs to be analyzed if the database update time is before the clock data update time; and determines that the data of the database does not need to be analyzed if the database update time is not before the clock data update time.

16. The electronic device as claimed in claim 15, wherein the database update time is a time that the data of the database changes, and the clock data update time is a time that the dates including the alarm function change according to the change data of the database.

17. The electronic device as claimed in claim 13, wherein the indicator of the database distinguishes whether a user goes to work or has a rest corresponding to the date.

18. The electronic device as claimed in claim 13, wherein the default rule is to used set the alarm function of the electronic device on weekdays, and is not used to set the alarm function of the electronic device on weekends.

19. The electronic device as claimed in claim 18, wherein the analyzing module further:
determines that the date of the electronic device does not need to set the alarm function and determines that the alarm function of the date does not need to be updated when the date of the electronic device is a weekend and the indicator corresponding to the date corresponds to when the user has a rest in the date;
determines that the date of the electronic device does not need to set the alarm function and determines that the alarm function of the date needs to be updated when the date of the electronic device is a weekday and the indicator corresponding to the date corresponds to when the user has a rest in the date;
determines that the date of the electronic device needs to set the alarm function and determines that the alarm function of the date needs to be updated when the date of the electronic device is a weekend and the indicator corresponding to the date corresponds to when the user goes to work in the date; and
determines that the date of the electronic device needs to set the alarm function and determines that the alarm function of the date does not need to be updated when the date of the electronic device is a weekday and the indicator corresponding to the date corresponds to when the user goes to work in the date.
